(19) United States
(12) Patent Application Publication
(10) Pub. No.: US 2005/0102670 A1
(43) Pub. Date: May 12, 2005

(54) Shared object memory with object management for multiple virtual machines

(76) Inventors: Robert F. Bretl, Beaverton, OR (US); David J. Monnie, Portland, OR (US); Darrel S. Schneider, Aloha, OR (US); Bruce J. Schuchardt, Newberg, OR (US); David M. Whitlock, Portland, OR (US); Eric J. Zoerner, Portland, OR (US); Michael A. Nastos, Portland, OR (US)

Correspondence Address: IPSOLON LLP, 805 SW BROADWAY, #2740, PORTLAND, OR, 97205, US

(21) Appl. No.: 10/690,218

(22) Filed: Oct. 21, 2003

(51) Int. Cl. G06F 9/455

(52) U.S. Cl. 718/1

(57) ABSTRACT

A shared object memory system that includes a shared object memory for storing encapsulated software objects that are directly accessible by plural object application processes. The shared object memory is distinct from the process memories of the object application processes and does not include an execution model. A shared object memory manager provides management of objects within the shared object memory.

### TECHNICAL FIELD

The present invention relates to object memories used with virtual machines and other process applications and, in particular, to a shared object memory that is shared by and provides direct object access to multiple process applications.

### BACKGROUND AND SUMMARY OF THE INVENTION

Virtual machine computers, referred to simply as virtual machines, have been developed to provide software that mimics a “complete” computer. One example is the Java™ virtual machine introduced by Sun Microsystems, Inc. and available for a variety of computer platforms to run programs written in the Java™ virtual machine-based programming language. Such a virtual machine functions as a computer platform that hides the operating system of the underlying hardware computer from applets and applications written in the programming language of the virtual machine.

Such virtual machines are a type of object application process that includes an execution model to run one or more threads (typically multiple threads) with regard to encapsulated software objects in a dedicated process memory that is local to the application process. In addition to being implemented as JAVA™ virtual machines for running programs written in the Java™ virtual machine-based programming language, object application processes may also be implemented as programs in the C or C⁺⁺ programming language or according to any comparable programming convention.

Object application processes like Java™ virtual machines are commonly associated with stand-alone or client-side computers where the object application process operates in conjunction with an operating system or an Internet browser, for example. It will be appreciated, however, that object application processes may also be operated in conjunction with or on a server computer that serves one or more client computers. The clients may be connected to the server directly or by networked connections. Server object application processes may be used in a variety of applications, including database and transaction applications.

The dedicated process memories of conventional object application processes are separate and distinct from each other. Conventional object application processes copy objects from each other or from other memory stores, but operate on objects only within their distinct and dedicated process memories. In some cases, object application processes could share data in a memory store, but such a store provided no management or accommodation for software objects.

For example, data from a shared cache would be stored or retrieved merely as data in blocks of memory rather than calling a specific object by name. As a consequence, the application process storing or retrieving the data had to manage memory offsets, fragmentation, object identity and composition, class information, garbage collection, etc. within the shared cache. The inefficiency and burden of such overhead prevented the use of shared memory for objects.

Accordingly, the present invention includes a shared object memory system that includes a shared object memory for storing encapsulated software objects that are directly accessible by plural object application processes. The shared object memory is distinct from the process memories of the object application processes and does not include an execution model. A shared object memory manager provides management of objects within the shared object memory.

The shared object memory system conserves overall memory in the host computer by providing access to shared data to each of multiple application processes. Data can be shared across multiple processes running on a single host computer, thereby providing a performance advantage over copying the data from one process to another. The shared object memory also provides a performance advantage over the sharing of data with a database management system since access to the shared object memory is much faster than accessing a persistent storage device such as a hard disk drive.

Moreover, with the shared data being modified in-place within the shared object memory the changes are instantly visible to other processes. In addition, the shared object memory system allows data to live longer than the life of a single application process. Conventionally, the data in each application process would be lost when the application process is ended.

Additional objects and advantages of the present invention will be apparent from the detailed description of the preferred embodiment thereof, which proceeds with reference to the accompanying drawings.

### BRIEF DESCRIPTION OF THE DRAWINGS

FIG. 1 is a block diagram illustrating a prior art virtual machine architecture adapted to Java virtual machine-based programming language.

FIG. 2 is a block diagram of a shared object memory system that supports management of objects and is accessible by multiple virtual machines or object application processes.

FIG. 3 is a flow diagram of a shared object memory method for forming and operating a shared object memory.

### DETAILED DESCRIPTION OF PREFERRED EMBODIMENT

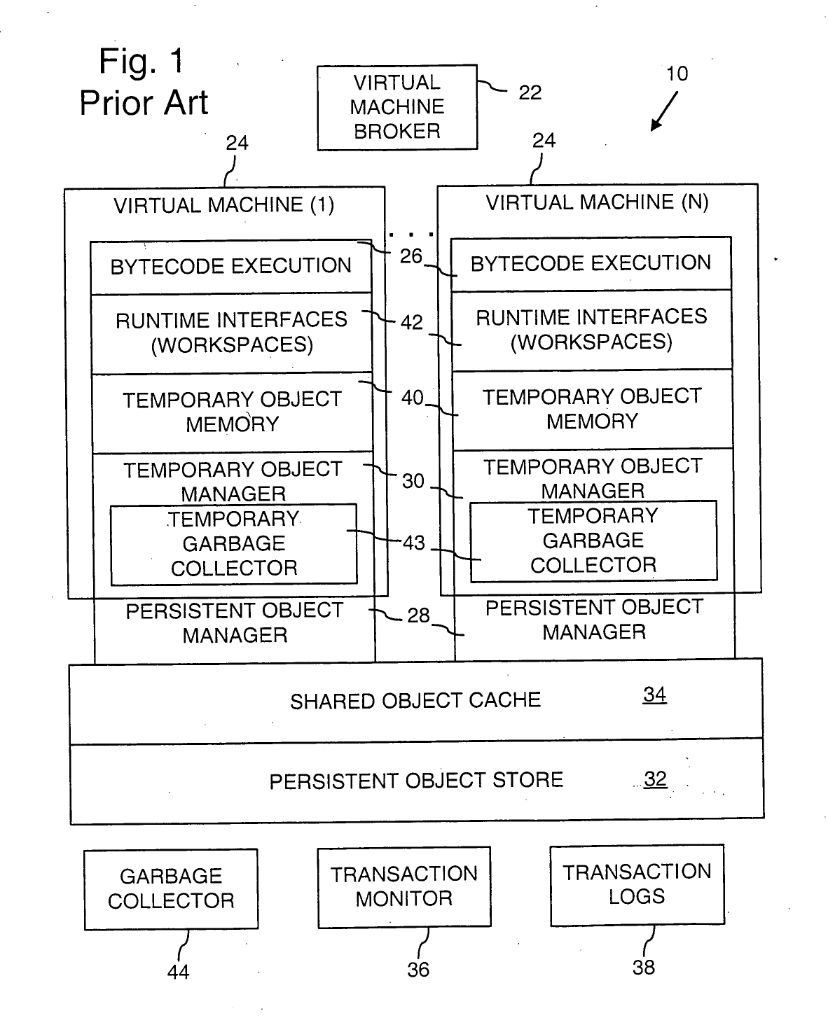

FIG. 1 is a block diagram illustrating a prior art virtual machine architecture 20 adapted to Java™ virtual machine-based programming language. It will be appreciated, however, that the present invention is similarly applicable to other virtual machine-based programming languages.

A virtual machine broker 22 manages a pool of N-number of server virtual machines 24 that may be selectively activated and are simultaneously operable. Virtual machine broker 22 receives at a designated communication port (not shown) requests for client services sent from clients 12. Virtual machine broker 22 assigns the client services to virtual machines 24 and can start virtual machines 24 or terminate them according to the client services being requested. Virtual machine broker 22 may also enforce login authentication of clients 12 requesting client services. In this implementation, each virtual machine 24 runs software in the Java programming language.

Each virtual machine 24 includes a bytecode execution module 26 that executes Java language programs. Such programs were originally written in the Java language and have been compiled into bytecodes. As is known in Java language programming, bytecodes are binary, machine-independent representations of a program that represent the program using a stack-oriented instruction set. As part of executing the bytecodes, virtual machine 24 may execute the bytecodes with an interpreter or may translate some or all of the bytecodes to machine instructions native to the underlying computer. Java programs may include native methods, which are portions of the program written in a language other than Java (such as the C programming language) and separately compiled into machine instructions native to the underlying computer. Native methods can be used to provide access from the Java language to operations within the virtual machine not accessible from the bytecode instruction set.

A persistent object manager 28 and a temporary object manager 30 in each virtual machine 24 operate on persistent and temporary objects, respectively, within the virtual machine 24. Within a multi-user database or transaction computing system, information in the database is stored, retrieved, created, and deleted as objects. The objects are asynchronously created, retrieved, changed and dereferenced by multiple independent users. Object managers 28 and 30 manage these activities to maintain the integrity of persistent or permanent objects (i.e., objects that have been fixed or committed in the database for system-wide use) and the views that the multiple users have of the persistent objects.

Object manager 30 provides users with new temporary objects and copies of persistent objects held in persistent object store 32. Object manager 28 locates persistent objects within object store 32 and can convert to persistent objects temporary objects passed from temporary object manger 30. In one implementation, the functionality of persistent object manager 28 and temporary object manager 30 are provided by an integrated object manager. The following description is directed to separate persistent and temporary object managers, but is similarly applicable to an integrated object manager.

With regard to persistent or permanent objects, persistent object manager 28 manages retrieval of objects from and storage of objects in a persistent object store 32 (i.e., disk I/O), and memory page allocation for reading and writing persistent objects and caching them in a shared cache 34 shared by all the virtual machines 24. Persistent object memory includes shared cache 34 and the persistent object store 32. The memory page allocation of persistent object manager 28 means that data stored in or retrieved from the persistent object memory merely as blocks of memory rather than calling a specific object by name.

In addition, persistent object manager 28 communicates with a transaction monitor 36 that manages shared resources (allocates persistent object identifiers, allocates memory blocks in persistent store) and enforces transaction integrity by recording changes to persistent objects in one or more transaction logs 38. Transaction logs 38 provide complete point-in-time roll-forward recovery.

With regard to temporary objects, temporary object manager 30 manages creation of temporary objects and creation of temporary copies of persistent objects in a temporary object memory 40 associated with multiple workspaces 42 for modification, deletion, or other manipulation by a user. Multiple workspaces 42 share a temporary object memory 40. All new and modified objects in the workspaces 42 are contained in the temporary object memory 40 until the transaction is committed.

Within the context of a transactional database application, a workspace 42 is a database session that is initialized by a user beginning a transaction. The transaction execution continues by accessing a graph or set of objects, sometimes called the working set, until the transaction is either committed to the database or the transaction is aborted. Objects read by different workspaces 42 may be held in shared object cache 34.

As is typical for Java language execution, each virtual machine 24 on virtual machine server 10 includes its own distinct temporary garbage collector 43, which is part of the temporary object manager 30. In this implementation, modified copies of persistent objects (sometimes referred to as “dirty” objects) are identified in a dirty object listing that is stored in temporary object memory 40. In particular, the dirty object listing lists all copies of persistent objects (i.e., objects that were copied from the persistent store) that have been modified by a workspace or within a transaction. Objects identified in the dirty object listing are protected from garbage collection until after the transaction involving the dirty objects is committed or aborted, as described below in greater detail. The dirty object listing or dirty set is a well-known object that the garbage collector 43 includes as part of its “root set”, using techniques well known in the art of building garbage collectors. The persistent object store includes a persistent garbage collector 44, which performs garbage collection of persistent objects in a manner that does not conflict with transaction processing.

In one implementation, virtual machine server 10 operates in a multi-threaded computer system, and each virtual machine 24 includes multiple threads and can support multiple simultaneous workspaces 42. Within each workspace 42, multiple threads are able to access objects simultaneously. Moreover, threads are orthogonal to workspaces 42 so that threads are not locked to particular workspaces 42, workspaces 42 are not locked to particular threads, and the sizes of the workspaces 42 are configurable to the requirements of the transactions within the workspaces. In a virtual machine server 10 with fewer threads than workspaces 42, this allows threads to be used by one workspace 42 after another. In an alternative implementation, each server virtual machine may have a single workspace that is tied to a single processing thread. However, virtual machines 22 in the illustrated implementation require less system memory and processing resources and hence can serve greater numbers of client services at greater speed than can server virtual machines in the alternative implementation.

It will be appreciated that multiple simultaneous workspaces and multiple simultaneous threads may be provided whether virtual machine 24 is operated on a computer having one or multiple CPUs. Such a concept of simultaneity of threads is a common construct. As is known in the art, however, the multiple simultaneous threads on a computer having only one CPU are actually time-multiplexed such that only one thread is actually being processed at a time. A computer having multiple CPUs may actually process as many threads simultaneously as there are CPUs.

Shared object cache 34 functions as a repository from which persistent objects may be retrieved or copied by temporary object manager 30 into temporary object memory 40 of a workspace 42 for modification, deletion, or other manipulation by a user. Objects are not modified, deleted, or manipulated while stored in shared object cache 34.

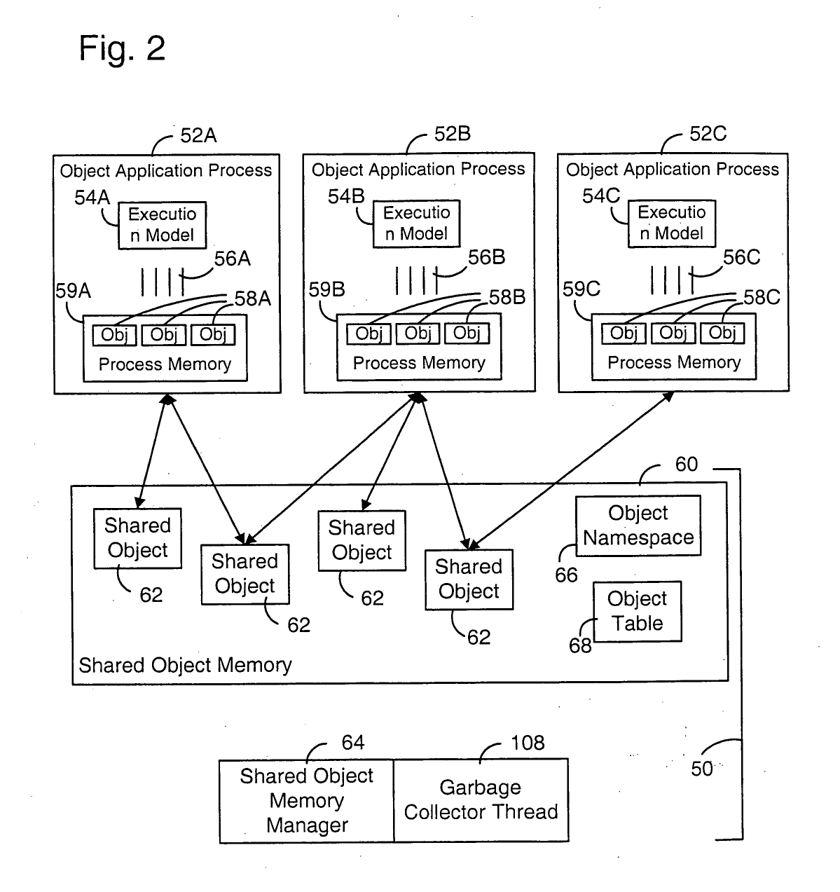

FIG. 2 is a block diagram of a shared object memory system 50 that supports management of objects and is accessible by multiple virtual machines or object application processes 52A-52C. Only three object application processes 52A-52C are shown, but it will be appreciated that there could be any plural number of them. Object application processes 52 generally references any or all of object application processes 52A-52C in which common elements are designated by a common reference numeral and the respective suffices A-C. Likewise, the common reference numerals reference the common elements of object application processes 52A-52C.

Each object application process 52 includes an execution model 54 to run one or more threads 56 (typically multiple threads 56) with regard to encapsulated software objects 58 in a dedicated process memory 59 that is local to the process 52. Object application processes 52 may be implemented, for example, as JAVA™ virtual machines for running programs written in the Java™ virtual machine-based programming language or as programs in the C or C⁺⁺ programming language or according to any comparable programming convention.

Shared object memory system 50 includes a shared object memory 60 within which is stored one or more objects 62 (multiple shown) that are directly accessible by any of object application processes 52. Direct access of objects 62 by any of object application processes 52 means that the objects 62 may be modified, manipulated, or operated on while resident in shared object memory 60. As a result, an object application process 52 operates on an object 62 in shared object memory 60 to substantially the same extent as if the object were in the process memory 59 of the application process 52.

A shared object memory manager 64 provides management of objects 62 in shared object memory 60, including object management functions such as compaction and garbage collection. Shared object memory system 50 and shared object memory 60 are distinct from object application processes 52 in that neither includes an execution model for executing threads with respect to software objects.

Shared object memory 60 includes an object namespace 66 that provides identification or a listing of objects 62 that reside in shared object memory 60. In one implementation, object namespace 66 includes a data structure such as:
ObjectName, ObjectID
in which the ObjectName field lists a name by which each object is called or accessed and the ObjectID field provides a reference for the object in an object table 68. In one implementation, object table 68 includes a data structure such as:
ObjectID, MemoryLocationPointer
in which the MemoryLocationPointer points to a location in shared object memory 60 where an object table entry (OTE) for the object is located. The object table entry, also called an object header, includes metadata relating to any locking of the object (e.g., while one or multiple object application processes accesses the object) and garbage collection of it

Object namespace 66 is used by an application process 52 to look up and directly access by name an object 62 that has been stored in shared object memory 60, such as by another application process 52. Namespace 66 and object table 68 together function as a hash table to or dictionary of objects 62 stored in shared object memory 60. Namespace 66 provides object identity mapping so application processes 52 can internally retrieve object data and references to other objects by use of object names or identifiers.

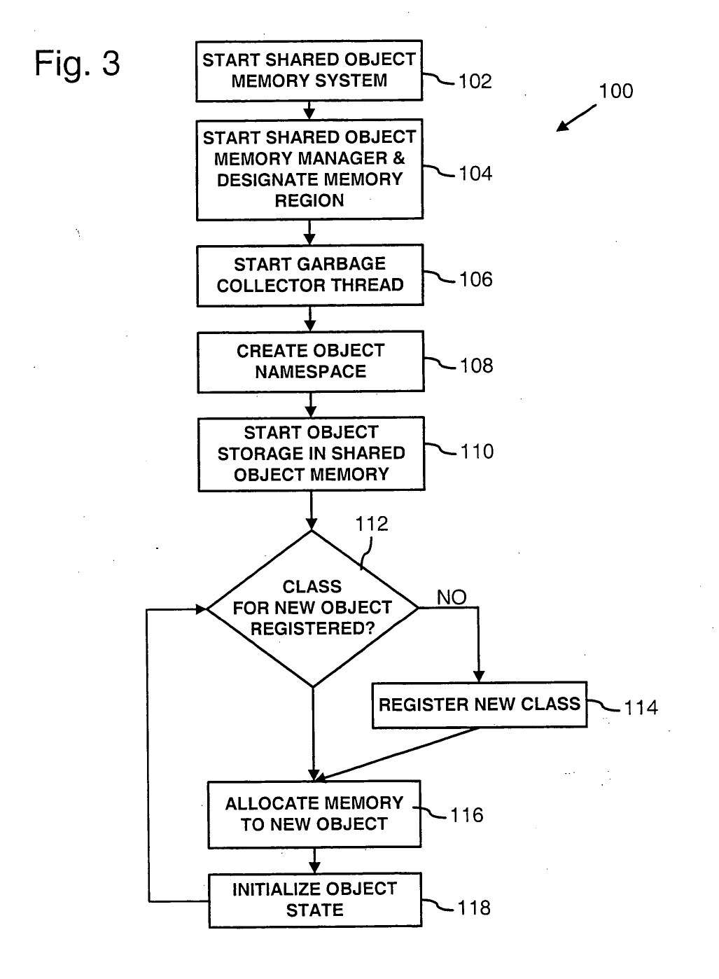

FIG. 3 is a flow diagram of a shared object memory method 100 for forming and operating shared object memory 60.

Process block 102 indicates that a shared object memory system is started.

In process block 104 a shared object memory manager 64 is started (e.g., as a process) and designates a region of memory in a host computer as shared object memory 60.

In process block 106 a shared object memory garbage collector thread 108 (FIG. 2) is started to provide garbage collection and memory allocation in shared object memory 60.

In process block 108 shared object memory manager 64 creates object namespace 66 for objects that reside in shared object memory 60. In addition to providing process applications 52 with access to objects 62 in shared object memory 60 by name, object namespace 66 is used by garbage collector thread 108 to dispose of unused objects 62. In one implementation, garbage collection thread 108 automatically disposes of objects 62 in shared memory 60 that are not reachable from object namespace 66 and that are no longer referenced in any application process 52 that is currently connected to shared object memory 60.

Namespace 66 is defined as a root object and functions to protect objects 62 from reclamation by garbage collector thread 108. Garbage collector thread 108 is aware that namespace 66 is a root object and it is therefore protected from reclamation.

In process block 110 storage of an object in shared object memory 60 is started.

Inquiry block 112 represents an inquiry as to whether an object class T for a new object is registered in shared object memory 60. Inquiry block 112 proceeds to process block 114 if the object class is not registered, and proceeds to process block 116 if the object class is registered.

In process block 114 the object class T is registered. Registration includes creating a new object table entry (OTE) for the class T, with a reference to it in object table 68 (FIG. 2). The new object table entry constructs a shared class T that includes the name, fields, size, etc. (e.g., JAVA classes also include bytecodes for execution) of the object class. This provides layout of object data in shared object memory 60 and tracking of the class that the object is an instance of. For example, the class registration determines the layout of the object 62 in shared object memory 60 in terms of its fields (i.e., references to other objects and the primitive data that it contains), the amount of memory space required, and calculation of memory offsets to read or update a field. Process block 114 proceeds to process block 116.

In process block 116 garbage collector 108 allocates a portion of shared object memory 60 to the new object. If insufficient memory is available, an error is generated.

In process block 118 the object state is initialized in the shared object memory 60. For example, the application process 52 storing the object 62 provides object state initialization by completing the fields of the object with primitive data (e.g., integers, floating point numbers, characters, etc.) or providing ObjectIDs of other shared memory objects. In a JAVA implementation, for example, process block 118 returns to process block 112 for each object that is referenced by the object 62 for which the object state is initialized. As a result, whenever an object 62 is created in shared object memory 60, all objects that are reachable from that object are also created in shared object memory 60 automatically.

In addition, shared object memory manager 64 may trigger a compaction of shared object memory 60 when remaining free space becomes low or when the amount of space reclaimed from objects that were garbage collected becomes high. In one implementation, the entire shared object memory 60 is passed over, bubbling any free space found toward a contiguous free space maintained between the area allocated for objects and an area at the other end of shared memory that is allocated for holding an object table. At the end of the pass, all free space is merged with the contiguous free space and shared memory is considered defragmented.

Namespace 66 and object table 68 function as linked lists of objects that identify “new” and “old” spaces in shared object memory 60. Garbage collection thread 108 may use well-known generation-scavenging algorithms to sweep over the “new” space, containing new objects and modified objects, to form a list of possible garbage objects. This list is then passed to each process accessing the shared object memory, and a voting algorithm vetoes any objects in the list that are being referenced by the process. At the completion of the voting cycle, the remaining possible garbage objects are cleared of their state and are put in a free object list. Objects can be reused out of the list directly or can be recycled by the compactor into contiguous free space.

A mark-sweep algorithm is also periodically run to remove garbage from the “old” space. With mark-sweep, each object in the shared object memory is examined to determine whether it is referenced directly, or indirectly, from namespace 66. Objects that fail the test are discarded and their identifiers are made available for reuse.

With multiple application processes 52 and threads 56 accessing objects 62 within shared object memory 60, shared object memory manager 64 also provides concurrency control by locking objects to control access by concurrent threads. This low-level locking may employ spin-locks, for example, as is known in the art.

In one implementation, steps of method 100 are implemented using native functions that are called by the process application 52. These native functions include a request to create an object 62 in shared object memory 60, the request returning an object identifier, a function to update a field in an object, and a function to read a field in an object.

Having described and illustrated the principles of our invention with reference to an illustrated embodiment, it will be recognized that the illustrated embodiment can be modified in arrangement and detail without departing from such principles. It should be understood that the programs, processes, or methods described herein are not related or limited to any particular type of computer apparatus, unless indicated otherwise. Various types of general purpose or specialized computer apparatus may be used with or perform operations in accordance with the teachings described herein. Elements of the illustrated embodiment shown in software may be implemented in hardware and vice versa.

In view of the many possible embodiments to which the principles of our invention may be applied, it should be recognized that the detailed embodiments are illustrative only and should not be taken as limiting the scope of our invention. Rather, we claim as our invention all such embodiments as may come within the scope and spirit of the following claims and equivalents thereto.

1. In a computer readable medium having plural object application processes that each include a separate execution model and a process memory for running programs with regard to encapsulated software objects, the improvement comprising:
a shared object memory in the computer readable medium storing encapsulated software objects that are directly accessible by the plural object application processes, the shared object memory not including an execution model and being distinct from the process memories of the object application processes; and
a shared object memory manager that provides management of objects within the shared object memory.

2. The medium of claim 1 in which the shared object memory manager provides garbage collection to remove unused objects in the shared object memory.

3. The medium of claim 1 further including an object namespace in the shared object memory listing software objects stored in the shared object memory.

4. The medium of claim 3 in which the shared object memory manager provides garbage collection to remove unused objects in the shared object memory according to whether the objects are referenced in the object namespace.

5. The medium of claim 3 in which the object namespace includes a data structure with a field ObjectName and a field ObjectID, in which the ObjectName field lists a name by which each object is accessed by an application process and the ObjectID field provides a reference for each object in an object table that includes a memory location pointer indicating a location where the object is located in the shared object memory.

6. The medium of claim 1 in which the shared object memory manager provides automatic creation in the shared object memory of each object that is referenced by a stored object.

7. The medium of claim 1 in which the shared object memory manager compacts the shared object memory when remaining free space becomes low.

8. The medium of claim 1 in which the shared object memory manager compacts the shared object memory when the amount of space reclaimed from objects that were garbage collected becomes high.

9. The medium of claim 1 in which each object in the shared object memory is of a class and the shared object memory manager provides registration of each class prior to an object of the class being stored in the shared object memory.

10. The medium of claim 1 in which the shared object memory manager provides for creation of objects in the shared object memory and initialization of object states with at least one of primitive data or reference to another object in the shared object memory.

11. The medium of claim 1 in which the object application processes include at least one Java virtual machine.

12. The medium of claim 1 in which the object application processes include at least one program in one of a family of C programming languages.

13. In a computer readable medium, shared object memory software for operating a shared object memory that is accessible by plural object application processes of a host computer that each include a separate execution model and a process memory for running programs with regard to encapsulated software objects, comprising:
software for allocating in the host computer a shared object memory that is distinct from the process memories of the object application processes;
software for creating software objects in the shared object memory;
software for providing the object application processes with direct access to the objects stored in the shared object memory; and
software for garbage collecting to remove unused objects in the shared object memory.

14. The medium of claim 13 in which the software for creating software objects in the shared object memory lists objects in an object namespace included in the shared object memory.

15. The medium of claim 14 in which the software for garbage collecting to remove unused objects in the shared object memory according to whether the objects are referenced in the object namespace.

16. The medium of claim 14 in which the object namespace includes a data structure with a field ObjectName and a field ObjectID, in which the ObjectName field lists a name by which each object is accessed by an application process and the ObjectID field provides a reference for each object in an object table that includes a memory location pointer indicating a location where the object is located in the shared object memory.

17. The medium of claim 13 in which the software for storing software objects in the shared object memory provides automatic storing in the shared object memory of each object that is referenced by a stored object.

18. The medium of claim 13 further comprising software for compacting the shared object memory when remaining free space becomes low.

19. The medium of claim 13 further comprising software for compacting the shared object memory when the amount of space reclaimed from objects that were garbage collected becomes high.

20. The medium of claim 13 in which each object in the shared object memory is of a class and the software for creating software objects in the shared object memory provides registration of each class prior to an object of the class being stored in the shared object memory.

21. The medium of claim 13 in which the software for creating software objects in the shared object memory provides for creation of objects in the shared object memory and initialization of object states with at least one of primitive data or reference to another object in the shared object memory.

22. The medium of claim 13 in which the object application processes include at least one Java virtual machine.

23. The medium of claim 13 in which the object application processes include at least one program in one of a family of C programming languages.
